(19) United States
(12) Patent Application Publication
(10) Pub. No.: US 2013/0297357 A1
(43) Pub. Date: Nov. 7, 2013

(54) PRODUCT RESERVATION SYSTEM AND METHOD THEREOF

(71) Applicant: DADNY INC., Taipei City (TW)

(72) Inventor: DANIEL SHIH, Taipei City (TW)

(73) Assignee: DADNY INC., Taipei City (TW)

(21) Appl. No.: 13/665,153

(22) Filed: Oct. 31, 2012

(30) Foreign Application Priority Data
May 4, 2012 (TW) 101116106

(51) Int. Cl. G06Q 10/02

(52) U.S. Cl. 705/5

(57) ABSTRACT

This invention discloses a product reservation system and a method thereof. The system comprises a server end and a user end. The system server has a database and a product reservation platform. The database stores a plurality of product data comprising a payment date thereof. The user end is connected to the system server to sign in to the product reservation platform to have access to the plurality of product data. The user end sends a reservation message when at least one product data is selected, and the reservation message includes a user data and the payment date corresponding to at least one product data. Wherein the server end sends a payment notification to the user end which correspond the user data before the payment date or at the payment date, so that the user can confirm the reservation message or cancel the reservation message.

### CROSS-REFERENCE TO RELATED APPLICATION

This application claims the benefit of Taiwan Patent Application No. 101116106, filed on May 4, 2012, in Taiwan Intellectual Property Office, the disclosure of which is incorporated herein in its entirety by reference.

### BACKGROUND OF THE INVENTION

1. Field of the Invention

The present invention generally relates to a product reservation system and the method thereof, in particular to a product reservation system capable of notifying the user before the payment date for the user to confirm or cancel a reservation for a specific product.

2. Description of the Related Art

Following the advances in science and technology, the habits and attitude of the people have changed accordingly. Previously, when people wished to dine at a restaurant, they would need to queue up at the premises. However, with the availability of the telephone and the internet, a booking can be made on-line or a by a phone call without the need of queuing up. For example, it is the same with purchasing a book from a book store, the desired book can be reserved and purchased on-line or by telephone and the book can be collected immediately once at the book store, there is no need to spend a large amount of time to search and find the book. Even plane tickets can be purchased on-line or by telephone, payment and boarding is made directly at the airport.

However, conventional reservation systems still often require a small sum to be paid at the time of booking, commonly does not provide cancellation of the booking or require a certain percentage of the transaction amount to be paid in order to cancel the booking, causing unnecessary inconveniences to users.

Accordingly, it is a primary objective of the present invention to provide an ideal product reservation system and the method thereof to improve the drawbacks of the conventional product reservation systems.

### SUMMARY OF THE INVENTION

Therefore, it is a primary objective of the present invention to provide a product reservation system and the method thereof in order to resolve the inconvenience of the conventional product reservation system.

To achieve the foregoing objective, the present invention provides a product reservation system. The system comprises a server end and a user end. The server end provides a product reservation platform and a database, wherein the database stores a plurality of product data, and each of the product data comprises a payment date. The user end is connected to the server end to sign in to the product reservation platform to have access to the product data, wherein when at least one of the product data is selected by the user end, the user end sends a reservation message to the server end, the reservation message comprises a plurality of user end data and the payment data corresponding to the selected product data

Preferably, the user end may send a confirmation instruction or a cancellation instruction to the server end after the user end receives the payment notification.

Preferably, the server end may delete the reservation message corresponding to the cancellation instruction the after the server end receives the cancellation instruction.

Preferably, the server end may be a mobile communication device or a personal computer.

Preferably, a portion of the product data are product demand data sent by the user end.

To achieve the foregoing objective, the present invention further provides a product reservation method. The method comprises the following steps of: providing a product reservation platform and a database by a server end, wherein the database stores a plurality of product data, each of the product data comprises a payment date; connecting the server end to sign in to the product reservation platform and read the product data by a user end; and sending a reservation message to the server end by the user end when at least one of the product data being selected, wherein the reservation message comprises a user end data and the payment data corresponding to the selected product data; wherein, the server end sends a payment notification to the user end corresponding to the user end data on or before the payment date for the user end to confirm or cancel the reservation message.

Preferably, the method further comprises the following step of: sending a confirmation instruction or a cancellation instruction to the server end by the user end after the user end receives the payment notification.

Preferably, the method further comprises the following step of: deleting the reservation message corresponding to the cancellation instruction by the server end after the server end receives the cancellation instruction.

Preferably, the server end may be a mobile communication device or a personal computer.

Preferably, a portion of the product data are product demand data sent by the user end.

To achieve the foregoing objective, the present invention further provides a.

In a preferred embodiment of the present invention.

The product reservation system and the method thereof according to the present invention have one or more the following advantages:

(1) The product reservation system and the method thereof according to the present invention can not only provide a reservation platform for users to reserve products, but also can send a payment notification to users on or before the payment date. Accordingly, a user can pay for the product reserved by the user or cancel the reservation after receiving the payment notification, which is more flexible than the conventional product reservation system.

(2) The product reservation system and the method thereof according to the present invention can receive a product demand data sent by the user. Accordingly, the server end of the system can inquire the price of the product corresponding to the product demand data for the user and send the related information to the user for the user to determine whether or not to reserve the product, which is more convenient than the conventional production reservation system.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the block diagram of the product reservation system in accordance with the present invention.

FIG. 2 is the first schematic view of the first preferred embodiment of the product reservation system in accordance with the present invention.

FIG. 3 is the second schematic view of the first preferred embodiment of the product reservation system in accordance with the present invention.

FIG. 4 is the schematic view of the second preferred embodiment of the product reservation system in accordance with the present invention.

FIG. 5 is the flow chart of the second preferred embodiment of the product reservation system in accordance with the present invention.

FIG. 6 is the flow chart of the product reservation method in accordance with the present invention.

### DETAILED DESCRIPTION OF THE PREFERRED EMBODIMENTS

Illustrative embodiments accompanying with figures are now described below to lead the characteristics, contents, advantages and effects of the invention to be understood by the Examiner. Figures are illustrated only for explanation, but are not drawn to scale and precise arrangement, and thus the scope of the invention should not be limited by the scale and arrangement illustrated in the figures.

The technical content of the present invention will become apparent by the detailed description of the following embodiments and the illustration of related drawings as follows.

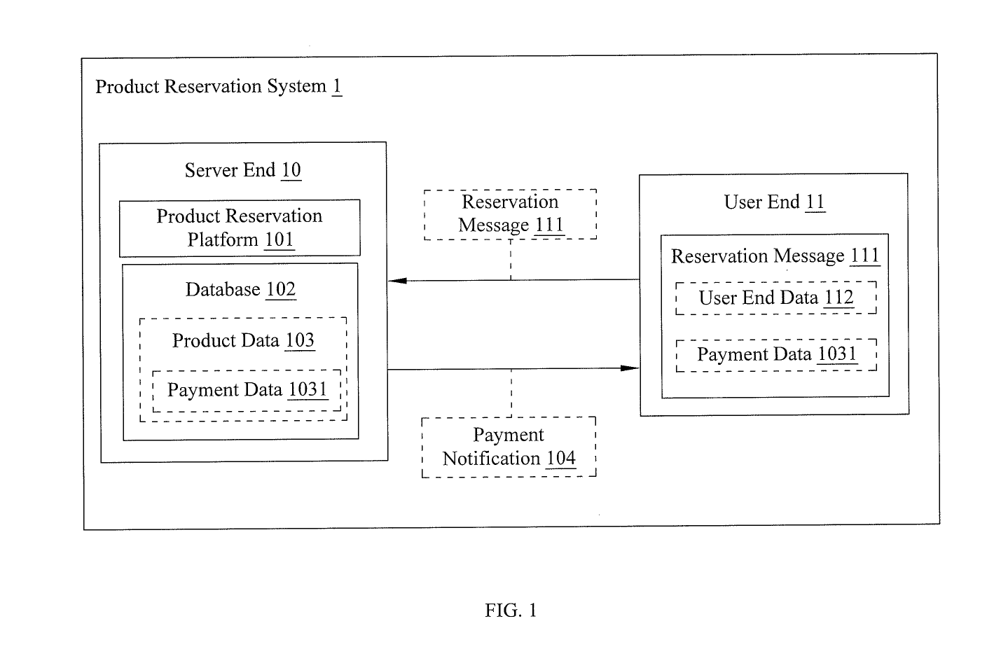

With reference to FIG. 1 for the block diagram of the product reservation system in accordance with the present invention. As shown in FIG. 1, the product reservation system 1 comprises the server end 10 and the user end 11. The server end 10 comprises the product reservation platform 101 and the database 102. The database 102 stores a plurality of product data 103, and each of the product data 103 comprises the payment date 1031. The user end 11 is connected to the server end 10 to sign in to the product reservation platform 101 and have access to the product data 103. When at least one of the product data 103 is selected by the user end 11, the user end 11 sends the reservation message 111 to the server end 10. The reservation message 111 may comprise the user end data 112 and the payment data 1031 corresponding to the selected product data 103. Wherein, the server end 10 sends the payment notification 104 to the user end 11 corresponding to the user end data 112 on or before the payment date 1031 for the user end 11 to confirm or cancel the reservation message 111.

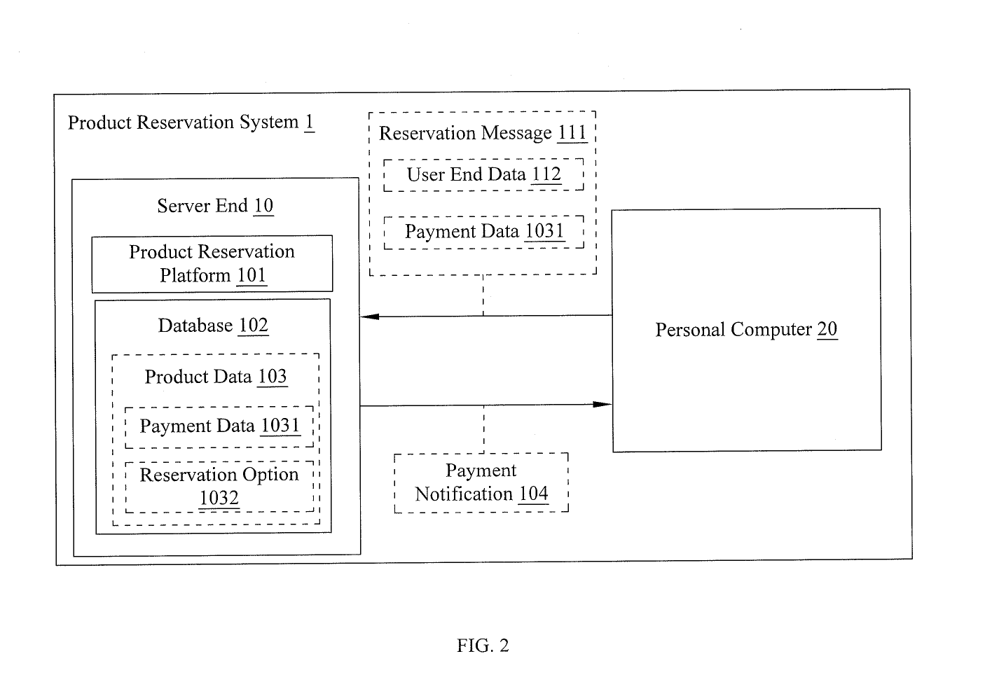

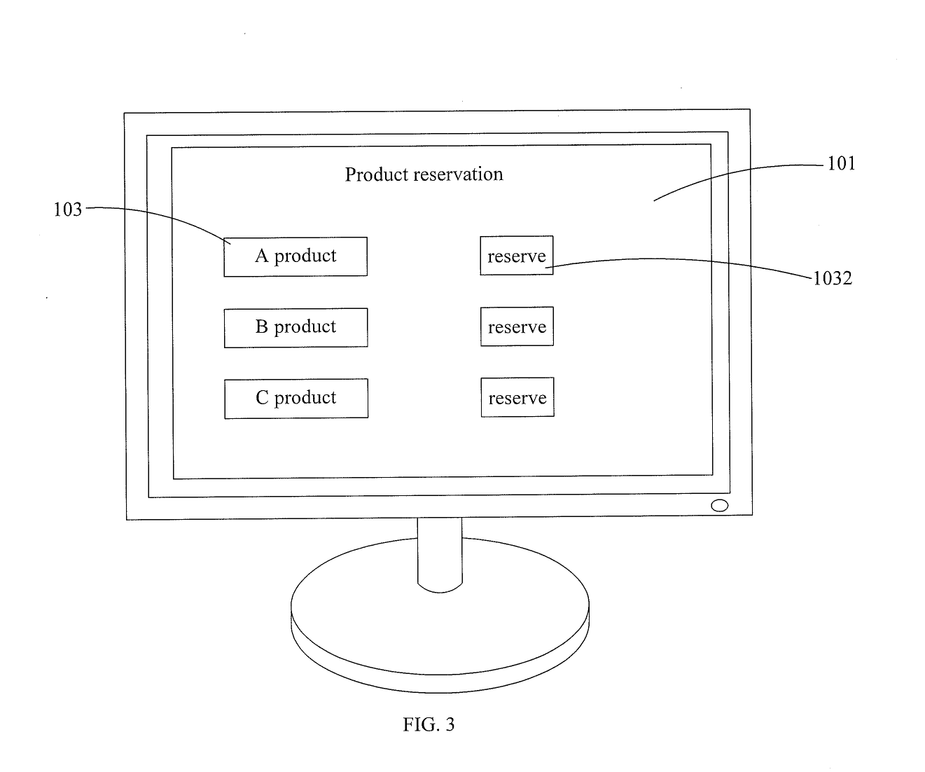

Please refer to FIG. 2 and FIG. 3. FIG. 2 is the first schematic view of the first preferred embodiment of the product reservation system in accordance with the present invention; FIG. 3 is the second schematic view of the first preferred embodiment of the product reservation system in accordance with the present invention. As shown in FIG. 2, the product reservation system 1 comprises the server end 10 and the user end 11. The server end 10 comprises the product reservation platform 101 and the database 102. The database stores a plurality of product data 103, and each of the product data 103 is corresponding to the payment date 1031. Wherein, the user end 11 may be the personal computer 20. A user may connect the server end 10 via the personal computer 20 to sign in to the product reservation platform 101 and have access to the product data 103. When one of the product data 103 is selected by the user, the personal computer 20 sends the reservation message 111 to the server end 10. Wherein, the product data 103 can further comprise the reservation option 1032 and the user can select the reservation option 1032 to reserve the product. The reservation message 111 may comprise the user end data 112 and the payment data 1031 corresponding to the selected product data 103. Wherein, the server end 10 sends the payment notification 104 to the personal computer 20 on the payment date 1031 after receiving the reservation message 111 and storing which in the database 102.

As shown in FIG. 3, more specifically, a user can connect the server end 10 via the personal computer 20 to sign in to the product reservation platform 101. A member mechanism can be designed according to the actual requirements for the product reservation platform 101 to obtain the related information of the users who sign in to the product reservation platform 101. After signing in to the product reservation platform 101, the user can read the product data 103, and each of the product data 103 comprises the reservation option 1032. The user can select any of the reservation options 1032 to reserve the product corresponding to the selected reservation option 1032. Moreover, the product data 103 can further comprise other options different from the reservation option 1032, such as an introduction option. For example, the user can select the introduction option of the product data 103 to sign in to the introduction page of the product corresponding to the product data 103. Also, the user can reserve the product in the introduction page. When the user selects one of the reservation options 1032, the personal computer 20 will send the reservation message 111 to the server end 10. Next, the server end 10 sends the payment notification 104 to the personal computer 20 on or before the payment data 1031 of the reservation message 111 after receiving and storing the reservation message 111. The user can read the payment notification 104 through the personal computer 20 and then pay for the product or cancel the reservation for the product. The product data 103 can be any product, such as tickets (plane ticket, entrance ticket and the like). The user can reserve a plane ticket (product data 103) and then the product reservation system 1 can send a billing notification (payment notification 104) to the personal computer 20 (user end 11). Next, the user can pay for the plane ticket or cancel the reservation for the plane ticket.

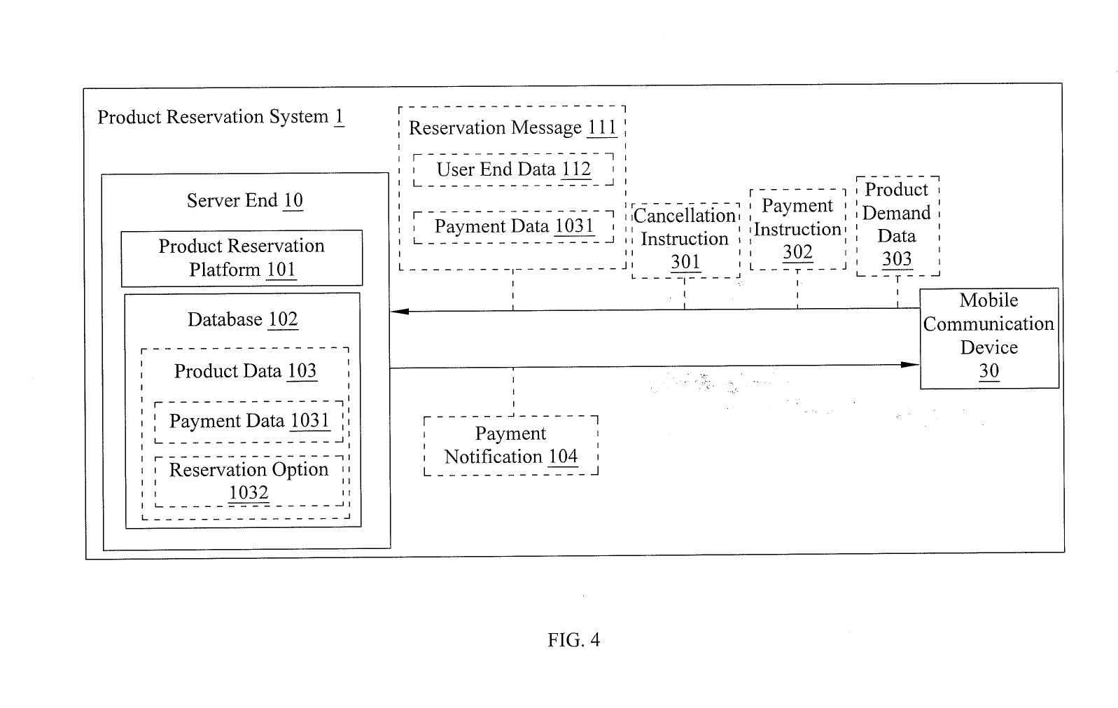

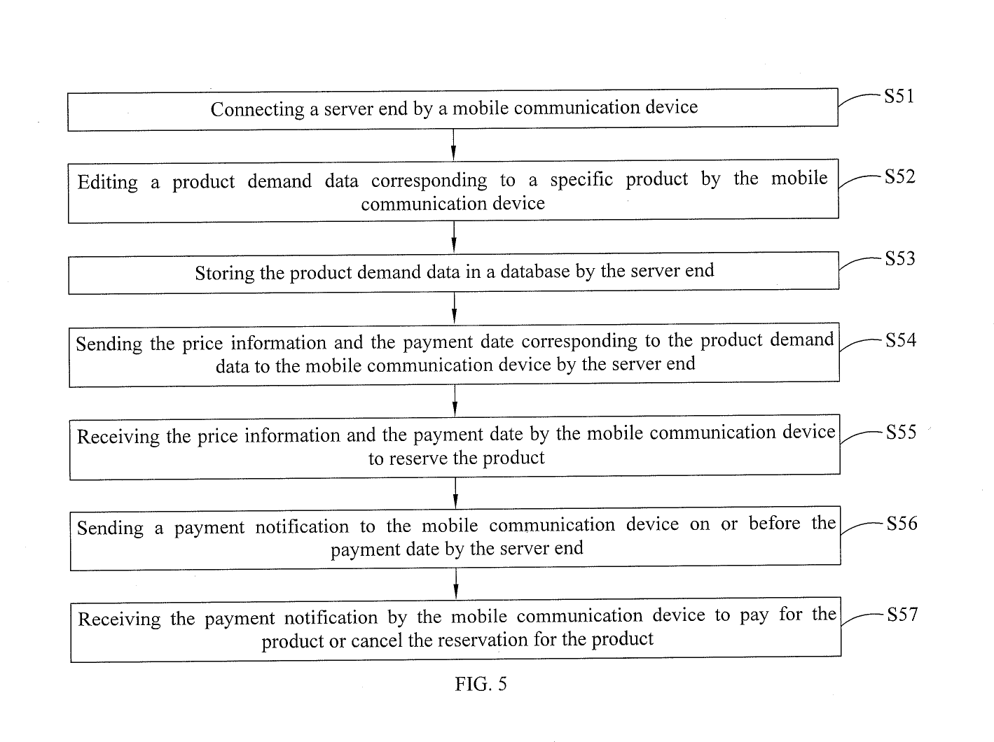

Please refer to FIG. 4 and FIG. 5. FIG. 4 is the schematic view of the second preferred embodiment of the product reservation system in accordance with the present invention; and FIG. 5 is the flow chart of the second preferred embodiment of the product reservation system in accordance with the present invention. As shown in FIG. 4, the product reservation system 1 is applicable to the mobile communication device 30. Specifically, the user end 11 can be the mobile communication device 30. A user may connect the server end 10 via the mobile communication device 30 to sign in to the product reservation platform 101 and have access to the product data 103 in the database 102. Wherein, each of the product data 103 can further comprise the reservation option 1032 and the user can select the reservation option 1032 to reserve the product. The user can select one of the reservation options 1032 to reserve the corresponding product after reading the product data 103 via the mobile communication device 30. Wherein, the mobile communication device 30 can connect the server end 10 through the 3^{rd}-generation technology (3G), wireless fidelity technology (Wi-Fi), or the other related technology. When one of the reservation options 1032 is selected by the user via the mobile communication device 30, the mobile communication device 30 sends the reservation message 111 to server end 10. The reservation message 111 may comprise the user end data 112 and the payment data 1031 corresponding to the selected product data 103. Wherein, the user end data 102 may comprise telephone number, user basic information or the related member information of the product reservation platform 101. The server end 10 sends the payment notification 104 to the mobile communication device 30 on or before the payment data 1031 of the reservation message 111 after receiving the reservation message 111 and then storing the reservation message 111 in the database 103. The user can determine to pay for the product or cancel the reservation for the product after the mobile communication device 30 receives the payment notification 104. If the user chooses to cancel the reservation, the mobile communication device 30 sends the cancellation instruction 301 to the server end 10. The server end 10 deletes the reservation message 111 corresponding to the cancellation instruction 301 after receiving the cancellation instruction 301. Wherein, if the user chooses to pay for the product, the mobile communication device 30 sends the payment instruction 302 to the server end 10. The server end 10 can send a transaction data (such as 2-dimension bar code) to the mobile communication device 30 or connect the mobile communication device 30 to an on-line bank for the user to pay for the product on-line. Besides, the user can edit the product demand data 303 through the mobile communication device 30 and store which in the database 102 of the server end 10. In actual application, the server end 10 can search the product and inquire the related information of the product corresponding to the product demand data 303 for the user (such as inquiring the prize of the product corresponding to the product demand data 303), and then make the product demand data 303 become one of the product data 103.

Briefly speaking, the user can connect the server end 10 to sign in to the product reservation platform 10 in order to read the product data 103 stored in the database 102. Each of the product data 103 may further comprise the corresponding reservation option 1032. When the user selects one (or more) of the reservation options 1032 to reserve a specific product, the mobile communication device 30 sends the reservation message 111 to the server end 10. The server end 10 sends the payment notification 104 to the mobile communication device 30 on or before the payment date 1031 of the reservation message 111 after receiving and storing the reservation message 111. The user can determine to pay for the product (on-line) or cancel the reservation for the product after the mobile communication device 30 receives the payment notification 104. If the user cancels the reservation, the user can send a cancellation instruction 301 to the server end 10 via the mobile communication device 30. The server end 10 deletes the reservation message 111 corresponding to the cancellation instruction 301 after receiving the cancellation instruction. The product reservation system 1 can further be applied to any product which can be reserved, which allows the user to determine to pay for a reserved product or cancel the reservation for a product after receiving the payment notification. Thus, the product reservation system is more flexible than the conventional reservation system.

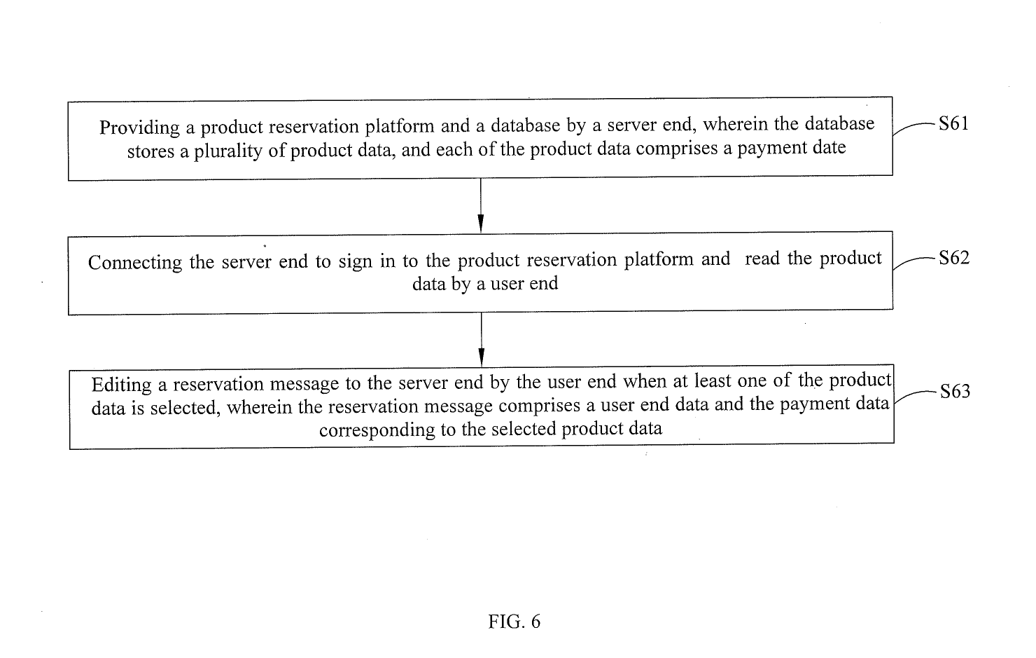

As shown in FIG. 6, the embodiment comprises the following steps of:

S51: connecting a server end by a mobile communication device.

S52: editing a product demand data corresponding to a specific product by the mobile communication device.

S53: storing the product demand data in a database by the server end.

S54: sending the price information and the payment date corresponding to the product demand data to the mobile communication device by the server end.

S55: receiving the price information and the payment date by the mobile communication device to reserve the product.

S56: sending a payment notification to the mobile communication device on or before the payment date by the server end.

S57: receiving the payment notification by the mobile communication device to pay for the product or cancel the reservation for the product.

With reference to FIG. 6 for flow chart of the product reservation method in accordance with the present invention. As shown in FIG. 6, the product reservation method comprises the following steps of:

S61: providing a product reservation platform and a database by a server end, wherein the database stores a plurality of product data, and each of the product data comprises a payment date.

S62: connecting the server end to sign in to the product reservation platform and read the product data by a user end.

S63: editing a reservation message to the server end by the user end when at least one of the product data is selected, wherein the reservation message comprises a user end data and the payment data corresponding to the selected product data.

Wherein, the server end sends a payment notification to the user end corresponding to the user end data on or before the payment date for the user end to confirm or cancel the reservation message.

The detailed description and the exemplary embodiments of the product reservation method in accordance with the present invention have been described in the description of the product reservation system; therefore, they will not be repeated herein again.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A product reservation system, comprising:
a server end, arranged for providing a product reservation platform and a database, wherein the database stores a plurality of product data, each of the product data comprises a payment date; and
a user end, being connected to the server end to sign in to the product reservation platform to have access to the product data, wherein when at least one of the product data is selected by the user end, the user end sends a reservation message to the server end, the reservation message comprises a user end data and a payment data corresponding to the selected product data;
wherein, the server end sends a payment notification to the user end corresponding to the user end data on or before the payment date for the user end to confirm or cancel the reservation message.

2. The product reservation system of claim 1, wherein the user end sends a confirmation instruction or a cancellation instruction to the server end after the user end receives the payment notification.

3. The product reservation system of claim 2, wherein the server end deletes the reservation message corresponding to the cancellation instruction the after the server end receives the cancellation instruction.

4. The product reservation system of claim 1, wherein the server end is a mobile communication device or a personal computer.

5. The product reservation system of claim 1, wherein a portion of the product data are product demand data sent by the user end.

6. A product reservation method, comprising the following steps of:
providing a product reservation platform and a database by a server end, wherein the database stores a plurality of product data, each of the product data comprises a payment date;
connecting the server end to sign in to the product reservation platform and read the product data by a user end; and
sending a reservation message to the server end by the user end when at least one of the product data being selected, wherein the reservation message comprises a user end data and a payment data corresponding to the selected product data;
wherein, the server end sends a payment notification to the user end corresponding to the user end data on or before the payment date for the user end to confirm or cancel the reservation message.

7. The product reservation method of claim 6, further comprising the following step of:
sending a confirmation instruction or a cancellation instruction to the server end by the user end after the user end receives the payment notification.

8. The product reservation method of claim 7, further comprising the following step of:
deleting the reservation message corresponding to the cancellation instruction by the server end after the server end receives the cancellation instruction.

9. The product reservation method of claim 6, wherein the server end is a mobile communication device or a personal computer.

10. The product reservation method of claim 6, wherein a portion of the product data are product demand data sent by the user end.
